(19) United States
(12) Patent Application Publication
(10) Pub. No.: US 2025/0043160 A1
(43) Pub. Date: Feb. 6, 2025

(54) HOT MELT ADHESIVE COMPOSITION THAT INCLUDES LIQUID RESIN OIL

(71) Applicant: H.B. Fuller Company, St. Paul, MN (US)

(72) Inventors: Evan Yuan, Guangzhou (CN); Andrew R. Michel, Plymouth, MN (US); Haiying Zhou, Arden Hills, MN (US)

(21) Appl. No.: 18/715,061

(22) PCT Filed: Nov. 30, 2022
(86) PCT No.: PCT/US2022/080629

§ 371 Date: May 30, 2024

Related U.S. Application Data
(60) Provisional application No. 63/264,700, filed on Nov. 30, 2021.

(51) Int. Cl. C09J 11/08; B32B 7/12; C09J 5/06; C09J 157/00

(52) U.S. Cl. CPC C09J 11/08; B32B 7/12; C09J 5/06; C09J 157/00

(57) ABSTRACT

A hot melt adhesive composition that includes polymer, tackifying agent, and liquid resin oil.

### CROSS REFERENCE TO RELATED APPLICATIONS

This application claims the benefit of U.S. Provisional Application No. 63/264,700, filed Nov. 30, 2021, which is incorporated herein.

### BACKGROUND

The invention is directed to formulating hot melt adhesive compositions with a liquid resin oil.

Hot melt adhesive compositions are solid at room temperature, flow when sufficient heat is added to the composition, and solidify upon cooling. Hot melt adhesive compositions often include a thermoplastic polymer, a tackifying resin, and a plasticizer. A small increase in the amount of tackifying resin in a hot melt adhesive composition accompanied by a corresponding decrease in the amount of plasticizer can increase the glass transition temperature (Tg) of the composition but also can cause relatively large increases in the viscosity of the composition due in part to the molecular weight of the tackifying resin. Liquid plasticizers can be used to decrease the viscosity and Tg of a hot melt adhesive composition. However, plasticizer can bleed out from a hot melt adhesive composition if present in too high of a concentration in the composition. This phenomenon is also known as phase separation or blooming. When a plasticizer phase separates from an adhesive composition it can impair, or even destroy, the ability of the adhesive to form an adhesive bond, an adhesive bond formed by the adhesive composition, or both.

When formulating a hot melt adhesive composition, it is important to refrain from including components that have a flash point that is near or at the temperatures at which the hot melt adhesive composition will be manufactured and applied.

Pressure sensitive adhesive compositions are adhesive compositions that exhibit finger tack at room temperature. A variety of classes of pressure sensitive adhesive compositions exist. Some pressure sensitive adhesive compositions are applied at room temperature. Some pressure sensitive adhesive compositions include a solvent and are referred to as solvent-based pressure sensitive adhesive compositions.

There is a need to find useful applications for the products that result from waste streams that occur in chemical manufacturing processes. Waste streams occur during the polymerization processes that are used to form tackifying resins. Some tackifying resin polymerization processes utilize monomers having five or nine carbon atoms (i.e., C5 or C9) and have a waste stream that is referred to as a “liquid resin oil.”

There is a need for a new hot melt adhesive composition.

### SUMMARY

In one aspect, the invention features a hot melt adhesive composition that includes polymer (e.g., a polymer selected from the group consisting of thermoplastic polymer, elastomeric polymer, and combinations thereof), tackifying agent, and a liquid resin oil derived from a waste stream of a tackifying resin polymerization process.

In another aspect, the invention features a hot melt adhesive composition that includes polymer (e.g., a polymer selected from the group consisting of thermoplastic polymer, elastomeric polymer, and combinations thereof), tackifying agent, and a liquid resin oil exhibiting a glass transition temperature (Tg) from −60° C. (or even −40° C.) to less than 0° C., having an aromatic content of at least 1.5%, and having an Mz of no greater than 600 g/mol.

In one embodiment, the liquid resin oil exhibits a Tg from −40° C. to less than 0° C., an aromatic content of at least 1.5%, and an Mz of no greater than 500 g/mol.

In another embodiment, the liquid resin oil has an Mz of no greater than 400 g/mol.

In one embodiment, the liquid resin oil has an aromatic content of at least 2%. In other embodiments, the liquid resin oil has an aromatic content of at least 3%. In another embodiment, the liquid resin oil has an aromatic content of at least 4%.

In other embodiments, the liquid resin oil has an aromatic content of at least 2% and a Mz of no greater than 800 g/mol.

In some embodiments, the liquid resin oil exhibits a Tg of no greater than 0° C.

In another embodiment, the liquid resin oil exhibits a Tg less than 0° C., an aromatic content of at least 1.5%, and a Mz from 140 g/mol to 600 g/mol. In some embodiments, the liquid resin oil exhibits a Tg from −60° C. to less than 0° C., has an aromatic content of at least 1.5%, and has a Mz from 120 g/mol to 500 g/mol. In other embodiments, the liquid resin oil exhibits a Tg from −40° C. to less than 0° C., has an aromatic content of at least 1.5%, and has a Mz from 120 g/mol to 500 g/mol.

In another embodiment, the composition comprises at least 25% by weight of the liquid resin oil.

In some embodiments, the thermoplastic polymer is selected from the group consisting of styrenic block copolymer, polyolefin polymer, ethylene-polyalpha olefin, ethylene-polar comonomer copolymer, and combinations thereof.

In other embodiments, the composition includes less than 60% by weight tackifying agent.

In another embodiment, the composition includes less than 10% by weight plasticizer.

In another embodiment, the composition further includes liquid plasticizer, the percent by weight liquid resin oil in the hot melt adhesive composition being greater than the percent by weight percent liquid plasticizer in the hot melt adhesive composition.

In some embodiments, the hot melt adhesive composition includes from 10% by weight to 35% by weight of the polymer, from 30% by weight to 65% by weight of the tackifying agent, and from 5% by weight to 50% by weight of the liquid resin oil.

In other embodiments, the hot melt adhesive composition includes from 10% by weight to 30% by weight of the polymer, from 35% by weight to 50% by weight of the tackifying agent, and from 15% by weight to 45% by weight of the liquid resin oil.

In another embodiment, the hot melt adhesive composition includes from 10% by weight to 25% by weight of the polymer, from 40% by weight to 50% by weight of the tackifying agent, and from 30% by weight to 45% by weight liquid resin oil.

In one embodiment, the composition is a hot melt pressure sensitive adhesive composition. In some embodiments, the hot melt pressure sensitive adhesive composition exhibits a peel adhesion strength of at least 0.4 N/5.08 cm, when tested according to the Dynamic Peel Adhesion test method using a PE/NW test sample.

In some embodiments, the hot melt adhesive composition exhibits a Tg from −15° C. to 35° C.

In other embodiments, the hot melt adhesive composition exhibits a softening point greater than 60° C.

In other aspects, the invention features an article that includes a first substrate, a hot melt adhesive composition disclosed herein, and a second substrate adhered to the first substrate through the adhesive composition.

The present inventors have unexpectedly discovered that a liquid resin oil waste stream from a tackifier resin polymerization process can be successfully formulated into a hot melt adhesive composition. The present inventors have also unexpectedly discovered that a liquid resin oil having the combined properties of a relatively high aromatic content relative to plasticizer oils, and a relatively low z average molecular weight (Mz) relative to tackifying resins can be successfully formulated into hot melt adhesive compositions. The present inventors have further unexpectedly discovered that the inclusion of such a liquid resin oil can decrease both the amount of plasticizer oil and the amount of tackifying agent required to formulate a hot melt adhesive composition. The present inventors have further unexpectedly discovered that such a liquid resin oil can be used to decrease the viscosity of a hot melt adhesive composition while maintaining a suitable glass transition temperature for the composition.

Other features and advantages will be apparent from the following description of the preferred embodiments and from the claims.

### Glossary

In reference to the invention, these terms have the meanings set forth below:

The phrase “tackifier resin polymerization process” means a polymerization process that utilizes monomers to form a tackifier resin.

The term “liquid” means a component that exhibits a kinematic viscosity of no greater than 5000 centistokes (cS) at 25° C. as determined according to ASTM D445 and a pour point of no greater than 30° C. as determined according to ASTM D97.

The term “resin oil” means an oil that is derived from petroleum.

### DETAILED DESCRIPTION

The hot melt adhesive composition includes a polymer, a tackifying agent, and a liquid resin oil (e.g., a liquid resin oil derived from a waste stream of a tackifier resin polymerization process, a liquid resin oil exhibiting a glass transition temperature of at least −60° C., and having an aromatic content of at least 1.5%, and combinations thereof). The hot melt adhesive composition can be pressure sensitive or non-pressure sensitive.

The hot melt adhesive composition also exhibits a viscosity of no greater than 15,000 centipoise (cP), no greater than 10,000 cP, no greater than 5000 cP, or even no greater than 2000 cP at 177° C., at 149° C., at 135° C., at 121° C., or even at 107° C.

Preferably the ratio of the liquid resin oil to the tackifying agent is at least 0.4:1, at least 0.5:1, at least 0.6:1 or even at least 0.7:1.

The hot melt adhesive composition optionally includes a plasticizer. Preferably the ratio of the weight of liquid resin oil to the weight of plasticizer present in the adhesive composition is at least 5:1, at least 6:1, or even at least 10:1.

The hot melt adhesive composition preferably exhibits a glass transition temperature (Tg) of from −25° C. to 35° C.

The hot melt adhesive composition preferably exhibits a peel adhesion of at least 0.5 Newtons per 5.08 centimeters (N/5.08 cm), at least 0.8 N/5.08 cm, or even at least 1.0 N/5.08 cm when tested according to the Dynamic Peel Adhesion test method.

The hot melt adhesive composition preferably exhibits a crossover temperature (Tx) of at least 50° C., at least 60° C., at least 70° C., or even at least 80° C.

### Polymer

The polymer of the hot melt adhesive composition is thermoplastic, elastomeric, or thermoplastic and elastomeric. Particularly useful classes of polymers include, e.g., styrenic block copolymers, polyolefin polymers, ethylene-polar comonomer copolymers, and combinations thereof.

The hot melt adhesive composition includes at least 5% by weight, at least 10% by weight, at least 15% by weight, no greater than 95% by weight, no greater than 60% by weight, no greater than 40% by weight, no greater than 35% by weight, no greater than 30% by weight, no greater than 25% by weight, no greater than 20% by weight, no greater than 15% by weight, from 5% by weight to 95% by weight, from 5% by weight to 60% by weight, from 5% by weight to 40% by weight, from 10% by weight to 40% by weight, from 10% by weight to 35% by weight polymer, from 10% by weight to 30% by weight polymer, or even from 10% by weight to 25% by weight polymer.

### Styrenic Block Copolymer

Useful styrenic block copolymers include, e.g., diblock, triblock, radial, multiblock, and tapered styrenic block copolymers. The styrenic block copolymer preferably is a triblock copolymer that optionally includes some diblock copolymer. The styrenic block copolymer includes styrene end blocks (A) and at least one midblock (B). It is to be understood that styrene can also be present in the block copolymer in positions other than the end block.

Suitable end blocks (A) include, e.g., styrene, alpha-methylstyrene, o-methylstyrene, m-methylstyrene, p-methylstyrene, p-tert-butylstyrene, 2,4-dimethylstyrene, 2,4,6-trimethylstyrene, and combinations thereof.

Suitable midblocks (B) include, e.g., elastomeric conjugated dienes (e.g., hydrogenated and unhydrogenated conjugated dienes), monoterpenes (e.g., hydrogenated and nonhydrogenated monoterpenes), sesquiterpenes (e.g., hydrogenated and nonhydrogenated sesquiterpenes), and combinations thereof. Suitable elastomeric conjugated diene midblocks B include, e.g., butadiene (e.g., polybutadiene), isoprene (e.g., polyisoprene), 2,3-dimethyl-1,3-butadiene, 1,3-pentadiene, 1,3-hexadiene, and combinations thereof, and hydrogenated versions thereof including, e.g., ethylene, propylene, butylene and combinations thereof (e.g., ethylene/butylene and ethylene/propylene), and combinations thereof. One example of a useful midblock B monoterpene is myrcene. One example of a useful midblock B sesquiterpenes is beta farnesene.

Useful styrenic copolymers include, e.g., styrene-butadiene, styrene-isoprene, styrene-butadiene-styrene, styrene-isoprene-styrene, styrene-ethylene-butylene-styrene, styrene-ethylene-propylene-styrene, styrene-ethylene-butylene-styrene-styrene, and combinations thereof. Useful styrenic triblock copolymers are commercially available under the JH series of trade designations from Ningbo Jinhai Chenguang Chemical Corporation (Zhejian, China) including JH-8161 styrene-isoprene-styrene, the GLOBALPRENE series of trade designations from LCY Group (Taiwan) including GLOBALPRENE 3546 styrene-butadiene-styrene and GLOBALPRENE 3542 styrene-butadiene-styrene block copolymers, the KRATON series of trade designations from Kraton Corporation (Houston, Texas) including, e.g., KRATON D 1163 SIS and D 1117 SIS, KRATON G 1652 SEBS, G 1657 SEBS, G 1726 SEBS, and G 1901 SEBS, KRATON MD1537 H styrene-ethylene/butylene-styrene block copolymer, and KRATON A1535 H styrene-ethylene/butylene/styrene-styrene block copolymer, under the EUROPRENE Sol T series of trade designations from EniChem (Houston, Texas), under the SEPTON series of trade designations from Septon Company of America (Pasadena, Texas) including SEPTON S 1001 SEPS block copolymer and SEPTON 4030, 4033, 4044, 4055 and 4077 block copolymers, styrenic block copolymers from Taiwan Synthetic Rubber Corporation (Taipei City, Taiwan) including VECTOR 4211, VECTOR 4411A, and DPX-660 styrene-isoprene-styrene block copolymers, styrenic block copolymers from Kuraray America Inc. (Houston, Texas) including, e.g., HSFC KL-SF 901 and KL-SF 902 hydrogenated styrene-farnesene block copolymers and HYBRAR H7125 and H7311 hydrogenated SIS block copolymers, and under the TUFTEC series of trade designations from Asahi Kasei Corporation (Tokyo, Japan) including, e.g., TUFTEC H1043 styrene-ethylene/butylene-styrene triblock copolymer.

When styrenic block copolymer is present in the hot melt adhesive composition, the hot melt adhesive composition includes at least 5% by weight, at least 10% by weight, no greater than 60% by weight, no greater than 40% by weight, no greater than 35% by weight, no greater than 30% by weight, no greater than 25% by weight, from 5% by weight to 60% by weight, from 0% by weight to 60% by weight, from 5% by weight to 40% by weight, from 10% by weight to 40% by weight, from 10% by weight to 35% by weight polymer, from 10% by weight to 30% by weight polymer, or even from 10% by weight to 25% by weight styrenic block copolymer.

### Polyolefin Polymer

Useful polyolefins include, e.g., crystalline polyolefins, semi-crystalline polyolefins, amorphous polyolefins (e.g., amorphous polyalphaolefins including metallocene-catalyzed and nonmetallocene catalyzed amorphous polyalphaolefins), and combinations thereof. Useful polyolefins include, e.g., ethylene/alpha olefin copolymers, propylene polymers, butene-1 polymers, and combinations thereof.

Useful ethylene/alpha olefin copolymers are derived from at least 50% by weight ethylene and less than 50% by weight alpha-olefin comonomer. Suitable alpha-olefin co-monomers include e.g., alpha-olefin monomers having at least three carbon atoms, at least four carbon atoms, from three carbon atoms to eight carbon atoms, and combinations of such monomers). Suitable alpha-olefin co-monomers include, e.g., propylene, butene, pentene, hexene, heptene, octene, nonene, decene, dodecene, 4-methyl-pentene-1, 3-methyl pentene-1,3,5,5-trimethyl-hexene-1, 5-ethyl-1-nonene, 1,9-decadiene, and combinations thereof. Specific examples of suitable ethylene-alpha-olefin copolymers include ethylene-propylene, ethylene-butene, ethylene-hexene, ethylene-octene, and combinations thereof. Useful ethylene/alpha olefin copolymers preferably exhibit a melt flow rate of at least 3 g/10 min as measured according to ASTM D1238A-20 at 230° C. using a 2.16 kg load.

Useful ethylene/alpha-olefin copolymers are commercially available under a variety of trade designations including, e.g., the ENGAGE and AFFINITY series of trade designations from The DowDuPont Chemical Company (Midland, Michigan) including ENGAGE 8400, ENGAGE 8401, ENGAGE 8402, ENGAGE 8200, AFFINITY GA 1950, AFFINITY GA 1900, and AFFINITY GA 1875 ethylene-octene copolymers, the QUEO series of trade designations from Borealis, the INFUSE series of trade designations from DowDuPont Chemical Company (Midland, Michigan) including INFUSE 9500 ethylene-octene copolymer, the SABIC POE series of trade designations from Saudi Basic Industries Corp. (Pittsfield, Massachusetts) including SABIC POE C30070D, the LUCENE series of trade designations from LG, the TAFMER series of trade designations from MITSUI, and the EXACT series of trade designations from ExxonMobil Chemical Company (Houston, Texas) including, e.g., EXACT 9061 ethylene butene copolymer.

Useful propylene homopolymers and copolymers are derived from at least 50% by weight propylene and less than 50% by weight alpha-olefin comonomer. Useful alpha-olefin co-monomers include, e.g., alpha-olefin monomers having at least two carbon atoms, at least four carbon atoms, from four carbon atoms to eight carbon atoms, and combinations of such monomers). Specific examples of useful alpha-olefin co-monomers include, e.g., ethylene, butene, pentene, hexene, heptene, octene, nonene, decene, dodecene, 4-methyl-pentene-1, 3-methyl pentene-1,3,5,5-trimethyl-hexene-1, 5-ethyl-1-nonene, 1,9-decadiene, and combinations thereof. Specific examples of suitable propylene-alpha-olefin copolymers include propylene-ethylene, propylene-butene, propylene-hexene, propylene-octene, and combinations thereof.

Useful propylene polymers are commercially available under a variety of trade designations including, e.g., the VISTAMAXX series of trade designations from ExxonMobil Chemical Company (Houston, Texas) including VISTAMAXX 8880, VISTAMAXX 8780, and VISTAMAXX 8380 propylene-ethylene copolymers, the LICOCENE series of trade designations from Clariant Int'l Ltd. (Muttenz, Switzerland) including, e.g., LICOCENE PP 1502, LICOCENE PP 1602, LICOCENE PP 2602, and LICOCENE PP 3602 propylene-ethylene copolymers, the AFFINITY series of trade designations from The Dow Chemical Company (Midland, Michigan) including AFFINITY GP1570 propylene-ethylene copolymer, propylene homopolymers available under the L-MODU series of trade designations from Idemitsu Kosan Co., Ltd. (Japan) including L-MODU S410 polypropylene and L-MODU S400 polypropylene, and polymers available under the REXTAC series of trade designations from Rextac LLC (Odessa, Texas) including, e.g., REXTAC 2180 polypropylene homopolymer, REXATC 2280 ethylene copolymer, REXTAC 2385 ethylene copolymer, REXATC 2585 ethylene copolymer, and REXATC 2780 butene-1 copolymer.

Useful polybutene-1 polymers include metallocene-catalyzed polybutene-1 polymers including, e.g., metallocene-catalyzed polybutene-1 homopolymers, metallocene-catalyzed polybutene-1 copolymers, and combinations thereof. Metallocene-catalyzed polybutene-1 copolymers are derived from at least 50% by weight butene and less than 50% by weight alpha-olefin comonomer. Useful alpha-olefin comonomers include, e.g., ethylene, propylene, hexene, octene, and combinations thereof. Useful metallocene-catalyzed polybutene-1 polymers are commercially available under a variety of trade designations including, e.g., KOATTRO series of trade designation from LyondellBasell Industries Holdings, B.V. (Netherlands) including KOATTRO PB M 1500M random polybutene-1/ethylene copolymer and KOATTRO PB M 1200M random polybutene-1/ethylene copolymer.

The polyolefin polymers can be prepared using a variety of catalysts including, e.g., a single site catalyst (e.g., metallocene catalysts (e.g., metallocene-catalyzed propylene polymers)), multiple single site catalysts, non-metallocene heteroaryl catalysts, Ziegler-Natta catalysts, and combinations thereof.

When polyolefin polymer is present in the hot melt adhesive composition, the hot melt adhesive composition includes at least 5% by weight, at least 10% by weight, no greater than 95% by weight, no greater than 60% by weight, no greater than 40% by weight, no greater than 35% by weight, no greater than 30% by weight, no greater than 25% by weight, from 5% by weight to 95% by weight, from 5% by weight to 60% by weight, from 5% by weight to 40% by weight, from 10% by weight to 40% by weight, from 10% by weight to 35% by weight polymer, from 10% by weight to 30% by weight polymer, or even from 10% by weight to 25% by weight polyolefin polymer.

When amorphous polyalpha olefins are present in the hot melt adhesive composition, the hot melt adhesive composition includes at least 5% by weight, at least 10% by weight, no greater than 95% by weight, no greater than 60% by weight, no greater than 40% by weight, no greater than 35% by weight, no greater than 30% by weight, no greater than 25% by weight, from 5% by weight to 95% by weight, from 5% by weight to 60% by weight, from 5% by weight to 40% by weight, from 10% by weight to 40% by weight, from 10% by weight to 35% by weight polymer, from 10% by weight to 30% by weight polymer, or even from 10% by weight to 25% by weight polymer amorphous polyalpha olefin.

### Ethylene-Polar Comonomer Copolymer

The term “ethylene-polar comonomer copolymer,” as used herein, refers to copolymers, terpolymers and higher order polymers of ethylene and a polar comonomer. The ethylene-polar comonomer copolymer is derived from at least 90 mole % ethylene and no greater than 10 mole % of the polar co-monomer. Useful polar co-monomers include vinyl acetate and alkyl acrylates (e.g., C1-C4 alkyl acrylate). Suitable ethylene-polar comonomer copolymers include, e.g., ethylene vinyl acetate, ethylene methyl acrylate, ethylene ethyl acrylate, ethylene n-butyl acrylate, ethylene acrylic acid, ethylene methyl-methacrylate, ethylene 2-ethylhexyl acrylate, and combinations thereof.

Useful ethylene vinyl acetate copolymers exhibit a melt index of less than about 2600 g/10 min, less than about 1100 g/10 min, at least 100 g/10 min, or even at least 150 g/10 min. Suitable ethylene vinyl acetate copolymers include no greater than 10 mole % (mol %), or even no greater than 8 mol % vinyl acetate. Suitable ethylene vinyl acetate copolymers include no greater than 22% by weight, or even no greater than 20% by weight vinyl acetate. Suitable copolymers of ethylene vinyl acetate are commercially available under the ATEVA series of trade designations including ATEVA 1850A and 1880A from AT Plastics, Inc. (Edmonton, Alberta, Canada), and the ESCORENE series of trade designations including, e.g., ESCORENE MV 2514 from ExxonMobil Chemical Company (Houston, Texas), and ALCUDIA PA-407, PA-410 PA-411 and PA-420 from REPSOL (Madrid, Spain).

Useful ethylene alkyl-acrylate copolymers exhibit a melt index less than about 2500 g/10 min, or even less than about 900 g/10 min and include no greater than 10 mol %, or even no greater than 8 mol % alkyl-acrylate. Suitable ethylene n-butyl-acrylate copolymers include no greater than 33% by weight, or even no greater than 30% by weight butyl acrylate. Useful ethylene n-butyl-acrylate copolymers are commercially available under the ALCUDIA trade designations including PA-27100 and PA-27150 from Repsol (Madrid, Spain) and the ENABLE trade designations from Exxon Chemical (Houston, Texas). Suitable ethylene methyl acrylate copolymers are commercially available under the OPTEMA trade designations from Exxon Chemical (Houston, Texas). Useful ethylene methyl-methacrylate copolymers are commercially available under the ACRYFT trade designations from Sumitomo Chemical Company (Tokyo, Japan).

When ethylene-polar comonomer copolymer is present in the hot melt adhesive composition, the hot melt adhesive composition includes from 0% by weight to 60% by weight, at least 5% by weight, at least 10% by weight, no greater than 60% by weight, no greater than 40% by weight, no greater than 35% by weight, no greater than 30% by weight, no greater than 25% by weight, from 5% by weight to 60% by weight, from 5% by weight to 40% by weight, from 10% by weight to 40% by weight, from 10% by weight to 35% by weight polymer, from 10% by weight to 30% by weight polymer, or even from 10% by weight to 25% by weight ethylene-polar comonomer copolymer.

### Tackifying Agent

The tackifying agent of the hot melt adhesive composition preferably has a Tg of at least −30° C., at least 25° C., or even at least 50° C., and a Ring and Ball softening point of less than 200° C., greater than 0° C., greater than 50° C., or even from 80° C. to 160° C. as determined by ASTM E28-58T. Suitable classes of tackifying agents include, e.g., hydrocarbon tackifying agents, rosin-based tackifying agents, terpene-based tackifying agents, and combinations thereof.

Useful hydrocarbon tackifying agents include, e.g., aliphatic and cycloaliphatic petroleum hydrocarbon tackifying agents, mixed aromatic and aliphatic modified hydrocarbon tackifying agents, aromatic modified aliphatic hydrocarbon tackifying agents, hydrogenated derivatives thereof, polyterpenes, and combinations thereof, including, e.g., branched, unbranched, and cyclic C5 resins, C9 resins, and C10 resins, hydrogenated C9 resins, hydrogenated dicyclopentadiene (DCPD), hydrogenated C5 resins, and combinations thereof.

Useful hydrocarbon tackifying agents are commercially available under a variety of trade designations including, e.g., the ESCOREZ series of trade designations from ExxonMobil Chemical Company (Houston, Texas) including, e.g., ESCOREZ 5637 aromatic modified, cycloaliphatic hydrocarbon resin, ESCOREZ 1310LC aliphatic hydrocarbon resin, ESCOREZ 5400 cycloaliphatic hydrocarbon resin, ESCOREZ 5415 cycloaliphatic hydrocarbon resin, ESCOREZ 5600 aromatic modified, cycloaliphatic hydrocarbon resin, ESCOREZ 5615 aromatic modified, cycloaliphatic hydrocarbon resin, and ESCOREZ 5690 aromatic modified, cycloaliphatic hydrocarbon resin, the EASTOTAC series of trade designations from Eastman Chemical Company (Kingsport, Tennessee) including, e.g., EASTOTAC H-100R, EASTOTAC H-100L, and EASTOTAC H130W hydrogenated hydrocarbon resins, the WINGTACK series of trade designations from Cray Valley HSC (Exton, Pennsylvania) including, e.g., WINGTACK 86 aromatically modified, C5 hydrocarbon resin, WINGTACK EXTRA aromatically modified, C5 hydrocarbon resin, WINGTACK 95 aliphatic C5 petroleum hydrocarbon resin, and WINGTACK 10 liquid aliphatic C5 resin, the PICCOTAC series of trade designations from Eastman Chemical Company (Kingsport, Tennessee) including, e.g., PICCOTAC 8095 aromatically modified, C5 hydrocarbon resin, PICCOTAC 1115 hydrocarbon resin, and PICCOTAC 1020 liquid aliphatic resin in mineral oil, the ARKON series of trade designations from Arakawa Europe GmbH (Germany) including, e.g., ARKON P-125 alicyclic saturated hydrocarbon resin, the REGALITE and REGALREZ series of trade designations from Eastman Chemical Company including, e.g., REGALITE R1125 fully hydrogenated hydrocarbon resin, REGALREZ 1126 hydrocarbon resin, and REGALREZ 1018 liquid, fully hydrogenated cycloaliphatic resin, and the RESINALL series of trade designations from Resinall Corp (Severn, North Carolina) including RESINALL R 1030 hydrogenated hydrocarbon resin.

Useful rosin-based tackifying agents include, e.g., rosin acids, rosin esters, wood rosin, tall oil rosin, gum rosin, distilled rosin, hydrogenated rosin, dimerized rosin, polymerized rosin, and combinations thereof. Examples of useful rosin esters include e.g., glycerol esters of pale wood rosin, glycerol esters of hydrogenated rosin, glycerol esters of polymerized rosin, pentaerythritol esters of natural and modified rosins including pentaerythritol esters of pale wood rosin, pentaerythritol esters of hydrogenated rosin, pentaerythritol esters of tall oil rosin, phenolic-modified pentaerythritol esters of rosin, and combinations thereof.

Useful commercially available rosin-based tackifying agents are available under a variety of trade designations including, e.g., the SYLVALITE series of trade designations from Arizona Chemical Company (Jacksonville, Florida) including, e.g., SYLVALITE RE-100L rosin ester, SYLVALITE 9100 rosin ester, KOMOTAC KAl00L gum rosin pentaerythritol ester from Komo Pine Chemicals, Guangzhou Komo Chemical Co., Ltd. (China), the WESTREZ and ALTATAC series of trade designations from ingevity Corp. (North Charleston, South Carolina) including, e.g., WESTREZ 5101P, WESTREZ 5295, ALTATAC 1000P, and ALTATAC 1000 rosin esters, the FORAL series of trade designations from Eastman (Kingsport, Tennessee) including, e.g., FORAL 105-E gum rosins and FORAL AX rosin acid, the TECKROS series of trade designations from Teckrez Inc. (Fleming Island, Florida) including, e.g., TECKROS D85 and D95 rosin esters, and the HERCOLYN series of trade designations from DRT (Dax, France) including, e.g., HERCOLYN D liquid methyl ester of hydrogenated rosin.

Examples of useful polyterpene resins include non-hydrogenated polyterpene resins, hydrogenated polyterpene resins, and copolymers and terpolymers of natural terpenes (e.g., styrene-terpene, alpha-methyl styrene-terpene and vinyl toluene-terpene), and combinations thereof. Polyterpene resins are commercially available under a variety of trade designations including, e.g., the SYLVARES series of trade designations from Kraton Corp. (Houston, Texas) including SYLVARES 6100 terpene resin and SYLVARES TR 25A liquid polyterpene resin, the DERCOLYTE series of trade designations from DRT Company (Dax, France) including, e.g., DERCOLYTE A115 terpene resin, and the PICCOLYTE series of trade designations from Pinova Inc. (Brunswick, Georgia) including PICCOLYTE F105 and PICCOLYTE A115 polyterpene resins.

The adhesive composition includes from 30% by weight to 70% by weight, from 30% by weight to 65% by weight, from 30% by weight to 60% by weight, from 35% by weight to 70% by weight, from 35% by weight to 50% by weight, from 40% by weight to 70% by weight, from 40% by weight to 60% by weight, from 40% by weight to 55% by weight, or even from 40% by weight to 50% by weight tackifying agent.

### Liquid Resin Oil

The liquid resin oil is derived from petroleum, is liquid at room temperature (i.e., from 20° C. to 25° C.), exhibits a Tg less than 0° C., and at least −60° C., at least −40° C., at least −35° C., at least −25° C., at least −15° C., from −60° C. to 0° C., or even from −40° C. to 0° C., and has an aromatic content of at least 0.5%, at least 1.0%, at least 1.5%, at least 2%, at least 2.5%, at least 3%, or even at least 4%. The liquid resin oil preferably has a z average molecular weight (Mz) of no greater than 800 g/mole (g/mol), no greater than 600 g/mol, no greater than 500 g/mol, no greater than 400 g/mol, at least 120 g/mol, at least 140 g/mol, at least 200 g/mol, from 140 g/mol to 600 g/mol, or even from 120 g/mol to 500 g/mol, an Mz-Mn value of no greater than 400, no greater than 300, no greater than 250, or even no greater than 200, an Mz-Mw value of no greater than 400, no greater than 300, no greater than 250, or even no greater than 200, and a polydispersity index of no greater than 1.4, no greater than 1.3, no greater than 1.25, or even no greater than 1.22.

Useful liquid resin oils exhibit a viscosity of less than 9000 cP, less than 5000 cP, less than 2500 cP, or even less than 1000 cP at 40° C.

Useful liquid resin oils have a flash point greater than 140° C., greater than 150° C., greater than 175° C., greater than 180° C., greater than 200° C., greater than 210° C., greater than 220° C., no greater than 225° C., or even no greater than 200° C.

Useful liquid resin oils are light yellow, or even water white, when viewed by the naked eye.

One useful source of liquid resin oil is a waste stream that arises from a tackifier resin polymerization process that includes polymerizing monomers that include five carbon atoms (C5), nine carbon atoms (C9), or combinations thereof to form a tackifier resin.

Useful liquid resin oils are commercially available from a variety of sources and under a variety of trade designations including, e.g., low viscosity JQ-4 liquid resin oil and high viscosity JQ-4 liquid resin oil from Henghe Materials & Science Technology Co. Ltd., Ningbo, China).

The adhesive composition includes at least 1% by weight, at least 5% by weight, at least 10% by weight, no greater than 55% by weight, from 5% by weight to 50% by weight, from 10% by weight to 50% by weight, from 15% by weight to 45% by weight, from 20% by weight to 45% by weight, from 30% by weight to 45% by weight, or even from 35% by weight to 45% by weight liquid resin oil.

### Optional Plasticizer

The hot melt adhesive composition optionally includes a plasticizer. Suitable plasticizers include solid plasticizers and plasticizers that are liquid at room temperature. Useful classes of plasticizers include, e.g., oils, and oligomeric and low molecular weight polymeric plasticizers that are liquid at room temperature, including naphthenic oils, paraffinic oils (e.g., cycloparaffin oils), mineral oils, gas to liquid oils, and combinations thereof.

Useful plasticizers are commercially available under a variety of trade designations including, e.g., CALSOL 5550 naphthenic oil and DRAKEOL 35 paraffinic oil, from Calumet Specialty Products Partners, LP (Indianapolis, Indiana), and PURETOL 35 paraffinic oil from Petro-Canada Lubricants Inc. (Ontario, Canada), CATENEX T145 paraffinic oil from Shell Oil Products US (Houston, Texas), NYFLEX 223 naphthenic oil from Nynas AB (Stockholm, Sweden), KAYDOL mineral oil from Sonneborn (Tarrytown New York), KRYSTOL 550 mineral oil from Petrochem Carless Limited (Surrey, England), and RISELLA X430 natural gas to liquid oil from Shell Oil Products US (Houston, Texas).

The hot melt adhesive composition optionally includes 0% by weight, no greater than 25% by weight, no greater than 20% by weight, no greater than 15% by weight, no greater than 10% by weight, or even from 1% by weight to 15% by weight plasticizer.

### Optional Wax

The hot melt adhesive composition optionally includes wax. Suitable waxes include non-functionalized waxes, functionalized waxes, and combinations thereof. Suitable classes of non-functionalized waxes include, e.g., Fischer-Tropsch waxes, polyolefin waxes (e.g., polyethylene waxes and polypropylene waxes), microcrystalline waxes, metallocene waxes, paraffin waxes, and combinations thereof.

Useful Fischer-Tropsch waxes are commercially available under a variety of trade designations including, e.g., the BARECO series of trade designations from Baker Hughes Inc. (Sugar Land, Texas) including, e.g., BARECO PX-100 and PX-105 Fischer Tropsch waxes, the SHELLWAX series of trade designations from Shell Malaysia Ltd. (Kuala Lumpur, Malaysia) including, e.g., SHELLWAX SX100 and SX105 Fischer Tropsch waxes, the VESTOWAX series of trade designations from Evonik Industries AG (Germany) including, e.g., VESTOWAX 2050 Fischer Tropsch wax, the SASOLWAX series of trade designations from Sasol Wax North America Corporation (Hayward, California) including, e.g., SASOLWAX H105, SASOLWAX C80, SASOLWAX H1, and SASOLWAX H4 Fischer-Tropsch waxes, and the SARAWAX series of trade designations from Shell Corporation (Malaysia) including, e.g., SHELL GTL SARAWAX SX70 and SARAWAX SX80 Fischer-Tropsch waxes.

Useful polyethylene waxes are commercially available under a variety of trade designations including, e.g., the EPOLENE series of trade designations from Westlake Chemical Corporation (Houston, Texas) including, e.g., EPOLENE N-21, EPOLENE N-14, EPOLENE N-34 and EPOLENE N-35 polyethylene waxes, the BARECO series of trade designations from Baker Hughes Inc. (Sugar Land, Texas) including, e.g., BARECO C4040 polyethylene wax, the AC series of trade designations from Honeywell Int'l Inc. (Morristown, New Jersey) including, e.g., A-C 8 and A-C 9 polyethylene waxes, and the POLYWAX series of trade designations including POLYWAX 400, POLYWAX 500, POLYWAX 600, POLYWAX 655, and POLYWAX 725 polyethylene waxes from NuCera Solutions (Houston, Texas).

Useful polypropylene waxes are commercially available under a variety of trade designations including, e.g., EPOLENE N-15 from Westlake Chemical, HONEYWELL AC1089 from Honeywell Int'l Inc., and LICOCENE 6102 from Clariant Int'l Ltd. (Muttenz, Switzerland).

Useful microcrystalline waxes are commercially available under a variety of trade designations including, e.g., the MICROSERE series of trade designations from Alfa Chemicals (United Kingdom) including MICROSERE 5999A microcrystalline wax.

Useful paraffin waxes are commercially available under a variety of trade designations including, e.g., under the PARVAN series of trade designations from ExxonMobil Chemical Company (Houston, Texas) including, e.g., PARVAN 1580 and PARVAN 1520 paraffin waxes, and under the CALUMET series of trade designations from Calumet Specialty Products Partners, LP (Indianapolis, Indiana) including CALUMET FR-6513 paraffin wax.

Examples of suitable functionalized waxes include functionalized polypropylene wax (e.g., maleated polypropylene wax and oxidized polypropylene wax), functionalized polyethylene wax (e.g., maleated polyethylene wax and oxidized polyethylene wax), polar waxes, functionalized stearamide waxes (e.g., hydroxystearamide, N-(2-hydroxy ethyl)-12-hydroxystearamide, N,N′-ethylene bis 12-hydroxystearamide, and 12-hydroxy stearic acid N,N′-ethylene-bis stearamide), and combinations thereof. Useful commercially available functionalized waxes include, e.g., A-C 597P, A-C 596P, and A-C 1325 maleated polypropylene waxes and A-C 573 maleated polyethylene wax all of which are available from Honeywell Int'l Inc. (Morristown, New Jersey), and EPOLENE E 43 maleated polypropylene wax available from Westlake Chemical Corporation (Houston, Texas).

To the extent that wax is present in the hot melt adhesive composition, the hot melt adhesive composition includes from 0% to less than 5% by weight, from 0.5% by weight to 5% by weight, from 1% by weight to 4% by weight, or even from 1% by weight to 3% by weight wax.

### Additional Components

The hot melt adhesive composition optionally includes additional components including, e.g., additional polymers, antioxidants, adhesion promoters, ultraviolet light stabilizers, rheology modifiers, biocides, corrosion inhibitors, dehydrators, colorants (e.g., pigments and dyes), fillers, surfactants, flame retardants, and combinations thereof.

Useful antioxidants include, e.g., pentaerythritol tetrakis[3,(3,5-di-tert-butyl-4-hydroxyphenyl)propionate], 2,2′-methylene bis(4-methyl-6-tert-butylphenol), phosphites including, e.g., tris-(p-nonylphenyl)-phosphite (TNPP) and bis(2,4-di-tert-butylphenyl)4,4′-diphenylene-diphosphonite, di-stearyl-3,3′-thiodipropionate (DSTDP), and combinations thereof. Suitable antioxidants are commercially available under a variety of trade designations including, e.g., the IRGANOX series of trade designations including, e.g., IRGANOX 1010, IRGANOX 565, and IRGANOX 1076 hindered phenolic antioxidants, and IRGAFOS 168 phosphite antioxidant, all of which are available from BASF Corporation (Florham Park, New Jersey), and ETHYL 702 4,4′-methylene bis(2,6-di-tert-butylphenol). When present, the adhesive composition preferably includes from about 0.1% by weight to 2% by weight antioxidant.

### Uses

The hot melt adhesive composition is useful in a variety of forms including, e.g., as a coating (e.g., continuous coatings and discontinuous coatings (e.g., random, pattern, and array)), bead, film (e.g., a continuous films and discontinuous films), fibers, and combinations thereof.

The hot melt adhesive composition can be applied to or incorporated in a variety of substrates and articles including, e.g., woven and nonwoven webs (e.g., webs made from fibers (e.g., yarn, thread, filaments, microfibers, blown fibers, and spun fibers) and nonwoven polypropylene webs), films (e.g., polyolefin films (e.g., polypropylene and polyethylene films), nylon, rayon, polyester, polyvinyl chloride, polyurethane, and combinations thereof), perforated films, tape backings, fibers, substrates made from fibers (e.g., synthetic polymer fibers (e.g., nylon, rayon, polyesters, acrylics, polypropylenes, polyethylene, polyvinyl chloride, and polyurethane synthetic polymer fibers), virgin fibers, recycled fibers, cellulose fibers (e.g., natural cellulose fibers such as wood pulp), natural fibers (e.g., cotton, silk and wool), fibers made from natural materials including, e.g., polylactic acid, and glass fibers, and combinations thereof)), release liners, porous substrates, sheets (e.g., paper, and fiber sheets), paper products, labels (e.g., paper and polypropylene labels), substrates used in diapers, feminine hygiene (e.g., sanitary napkins), adult incontinence articles, containers (e.g., polyethylene terephthalate, polypropylene, and polyethylene), and combinations thereof.

Formulations of the hot melt adhesive composition are useful as a construction adhesive to bond polymer films (e.g., a diaper back sheet) to a nonwoven substrate, to bond two nonwoven substrates together, and combinations thereof. Such construction adhesive compositions preferably have a glass transition (Tg) temperature of from 0° C. to 35° C., from 0° C. to 30° C., or even from 5° C. to 25° C.

Formulations of the hot melt adhesive composition are useful as a core adhesive to fix the location of the diaper core (e.g., fluff, superabsorbent polymer, and combinations thereof) during manufacture and use of the diaper. Such core adhesive compositions are formulated as described above and preferably have a Tg from −10° C. to 20° C.

Formulations of the hot melt adhesive composition are useful as an elastic attachment adhesive to bond elastic strands to polyethylene or polypropylene films and nonwoven substrates. Such elastic attachment adhesive compositions are formulated as described above and preferably have a Tg from 5° C. to 35° C.

Formulations of the hot melt adhesive composition are useful as a positioning adhesive to enable positioning of a feminine hygiene product such as a sanitary napkin or pantyliner on an article of clothing, which can be made from a variety of materials including, e.g., cotton, synthetic microfiber, nylon, and combinations thereof. Such positioning adhesive compositions are formulated as described above and preferably have a Tg of from −15° C. to 20° C.

Formulations of the hot melt adhesive composition are useful as container labeling adhesives to attach a label (e.g., a polyolefin label or a paper label) to a polyethylene terephthalate, polypropylene, or polyethylene container (e.g., a plastic bottle). Such container labeling adhesive compositions are formulated as described above and preferably have a Tg from 0° C. to 30° C.

The hot melt adhesive composition can be applied using any suitable application method including, e.g., slot coating, spraying, spray coating (e.g., spiral spray, random spraying, and random fiberization (e.g., melt blowing), foaming, extrusion (e.g., applying a bead, fine line extrusion, single screw extrusion, and twin screw extrusion), wheel application, noncontact coating, contact coating, gravure, engraved roller, roll coating, transfer coating, screen printing, flexographic, “on demand” application methods, and combinations thereof. In on demand hot melt application systems (which are also referred to as “tank free” and “tankless” systems), hot melt compositions are fed in a solid state (e.g., pellets), to a relatively small heating vessel (relative to traditional hot melt applications systems that include a pot) where the hot melt composition is melted and, typically shortly thereafter, the molten liquid is applied to a substrate.

The invention will now be described by way of the following examples. All parts, ratios, percentages, and amounts stated in the Examples are by weight unless otherwise specified.

### EXAMPLES

### Test Procedures

Test procedures used in the examples include the following. All ratios and percentages are by weight unless otherwise indicated. The procedures are conducted at room temperature (i.e., an ambient temperature of from about 20° C. to about 25° C.) unless otherwise specified.

### Softening Point Test Method

Softening point is determined according to ASTM E28-99 entitled, “Standard Test Methods for Softening Point of Resins Derived from Naval Stores by Ring-and-Ball Apparatus,” using an automatic tester in which the ring and ball apparatus is submerged in glycerin. The brass rings are maintained at room temperature for at least 2 hours before testing is initiated.

### Flash Point Test Method

Flash point is determined according to ASTM D92-90 entitled, “Cleveland Open Cup Test Method.”

### Dynamic Mechanical Analysis (DMA) Test Method for Determining Glass Transition Temperature (Tg) and Crossover Temperature (Tx) of Hot Melt Adhesive Compositions

Glass transition temperature (Tg) of hot melt adhesive compositions is determined using Dynamic Mechanical Analysis (DMA) instrument and the following conditions: a gap of 1 mm, and heating the sample to 120° C., holding at 120° C. for 2 minutes, and then cooled to −20° C. at a rate of 3° C./minute, a frequency of 1 Hz and 5% strain. The Tg is the temperature at which the tan delta curve exhibits a local maxima at a material transition zone between the glassy and rubbery regions.

As temperature decreases from 120° C., storage modulus G′ and loss modulus G″ increase. The temperature, at which both of these curves cross over first time, is referred to as the crossover-temperature (Tx) and is reported in degrees Celsius.

### Test Method for Determining Glass Transition Temperature (Tg) for Liquid Plasticizers, Liquid Oil Resin, Liquid Tackifying Agents, and Solid Tackifying Agents

Glass Transition Temperature (Tg) for liquid plasticizers, liquid oil resin, and liquid tackifiers is determined using differential scanning calorimetry (DSC) according to ASTM D-3418-99 entitled, “Transition Temperatures of Polymers by Thermal Analysis” and ASTM E-794-06 entitled, “Standard Test Method for Melting and Crystallization Temperatures by Thermal Analysis,” using the following conditions: heating to 120° C. from 25° C. at a rate of 40° C. per minute, holding at 120° C. for 5 minutes (the first heating cycle), then cooling to −88° C. from 120° C. at a rate of 40° C. per minute, holding at −88° C. for 5 minutes, and then heating then from −88° C. to 120° C. at a rate of 10° C. per minute (the second heating cycle). The Onset Tg is obtained from the second heating cycle and is reported as the Tg of the sample. The results are reported in degrees Celsius (° C.).

### Molecular Weight Test Method

The number average molecular weight (Mn), weight average molecular weight (Mw) and z average molecular weight (Mz) are determined using size-exclusion chromatography (SEC).

### Sample Preparation

Approximately 0.02 g of a sample is mixed with 10 mL tetrahydrofuran (THF) and shaken using a shaker for two hours. The samples are then filtered through a 0.45 μm polytetrafluoroethylene (PTFE) filter.

### Mn, Mw, Mz Determination Test Method

Low Molecular Weight SEC: SEC is performed using THF as the eluent at 40° C. and two 7.5 mm (inner diameter), 300 mm (length) MESOPORE SEC columns held at 40° C., an ultraviolet light (UV) detector set to 254 nm and 300 nm followed by a refractive index (RI) detector. The system is calibrated using polystyrene standards having Mws ranging from 0.371 kDa to 19.50 kDa. The UV and RI detectors are connected in series. The sample passes through the UV detector 0.2 min before it is detected by the RI detector. The elution time from the UV trace is adjusted to overlay the RI/UV data. To overlay the UV and RI traces for comparison, approximately 0.2 min is added to the elution time of the UV trace. The resulting values are reported in grams per mole (g/mol).

### Viscosity Test Method

The viscosity of the hot melt adhesive composition is determined in accordance with ASTM D-3236 entitled, “Standard Test Method for Apparent Viscosity of Hot Melt Adhesives and Coating Materials,” (Oct. 31, 1988) using a Brookfield Thermosel Viscometer Model RVDV 2+ and spindle number 27. The viscosity of the sample to be tested is stabilized at the specified temperature for at least 30 minutes before the results are recorded. The results are reported in centipoise (“cP”).

### Aromatic Content Test Method

### Sample Preparation

Approximately 70 milligrams (mg) of the sample to be tested is added to 700 microliters (μL) of deuterated chloroform (CDCl3) with tetramethylsilane (TMS) in a 3 millimeter (mm) High Throughput NMR tube by Wilmad.

### Test Method

The aromatic content is obtained using H-1 Nuclear Magnetic Resonance (1H-NMR) Spectroscopy on a Bruker Ascend III HD 400 MHz Spectrometer equipped with a SMARTprobe set to 25° C. An appropriate relaxation time (e.g., greater than 2.5 seconds) and number of acquisitions are used to collect the results.

The sum (sum A) of the signals from 5.8 ppm to 8.0 ppm is obtained. The sum (sum T) of all of the signals from 0.2 ppm to 3.7 ppm and 4.3 ppm to 8.0 ppm is obtained. The percent sum A represents of the total sum T is then calculated according to the following equation % sum A=[sum A/sum T]×100). The result is reported as the aromatic content in units of percent.

If additives are present in the liquid resin oil sample, the respective resonances for the additives are omitted from the integration regions defined.

### Dynamic Peel Adhesion PE/NW Test Sample Preparation Method

A roll to roll coater (Catbridge Machinery, Montville, New Jersey) configured with a SUMMIT spray applicator (Nordson Corporation, Westlake, Ohio) having two orifices is used to prepare the test samples. The spray applicator has a spray pattern width of 5.08 mm. The system is set to a melt tank temperature of 150° C., an application temperature of from 155° C. to 160° C., a nip pressure of 3 pounds per linear inch (PLI) (i.e., 525 Newtons per meter), an application weight of 3 g/m², and minimal rewind and unwind tensions so as not to stretch the substrate being coated. The hot melt adhesive composition is applied continuously at a coat weight of 3 g/m² to a first substrate, which is the corona treated side of a breathable polyethylene film having a basis weight of 14 g/m² (PE), as the first substrate is passed through the applicator at a speed of 100 meters per minute (m/min). A second substrate, which is a spunbond polypropylene nonwoven web having a basis weight of 15 g/m² (NW), traveling at the same speed as the first substrate, is then nipped into place against the adhesive composition and the first substrate to form a laminate. Samples are collected after the coater has stabilized but at a minimum after at least 2 minutes of application.

Samples are then conditioned at the specified conditions for the specified period of time, allowed to equilibrate to room temperature, and then tested according to the Dynamic Peel Adhesion Test Method.

### Dynamic Peel Adhesion NW/NW Test Sample Preparation Method

The Dynamic Peel Adhesion NW/NW Test Sample Preparation Method is conducted according to the Dynamic Peel Adhesion PE/NW Test Sample Preparation Method with the exception that both the first substrate and the second substrate are spunbond propylene nonwoven webs having a basis weight of 15 g/m² (NW).

### Dynamic Peel Adhesion Test Method

Dynamic Peel is determined according to ASTM D1876-01 entitled, “Test Method for Determining Peel Resistance of Adhesive (T-Peel Test Method).” The test samples are run on an Instron 3343 test instrument at a cross head speed of 250 mm/min in the machine direction. Test samples, 3 in. by 2 in., are cut from the test samples prepared as described in the Sample Preparation Method for Dynamic Peel Adhesion Test. The effective testing area of the test sample is 2 in. by 2 in. Five test samples are prepared for each sample composition. The peel adhesion value of each of the five samples is obtained and the average peel value is calculated. The result is recorded as the peel adhesion in units of Newtons/2 inch (N/2 in) and then converted to Newtons per 5.08 centimeter (N/5.08 cm).

### Analysis of Components

Three grades of JQ-4 liquid resin oil, ESCOREZ 5400 cycloaliphatic hydrocarbon resin, CALSOL 5550 naphthenic oil, KN-4010 naphthenic oil, ER-400 hydrogenated hydrocarbon resin and REGALREZ 1018 liquid hydrocarbon resin were analyzed according to the Molecular Weight, Viscosity, Flash Point, Tg, and Aromatic Content test methods, with exceptions to the methods being noted in footnotes to Table 1 and with the exception that the Viscosity was measured at the temperature specified in Table 1. The polydispersity index was calculated based on the measured Mn and Mw (i.e., Mw/Mn). The results are reported in Table 1.

TABLE 1

| | | | | | | Flash | | Aromatic |
|---|---|---|---|---|---|---|---|---|
| | Mn | Mw | Mz | | Viscosity | Point | Tg | Content |
| Sample | (g/mol) | (g/mol) | (g/mol) | PD | (cP) | (° C.) | (° C.) | (%) |
| JQ-4 (high | 157 | 193 | 233 | 1.23 | 1130 at | 182.2^{a} | −28 | 4.4 |
| viscosity | | | | | 40° C. | | | |
| grade) | | | | | | | | |
| JQ-4(low | 190 | 217 | ND | 1.14 | 105 at | 161^{a} | ND | ND |
| viscosity | | | | | 40° C. | | | |
| grade) | | | | | | | | |
| JQ-4(low | 66 | 90 | 124 | 1.37 | 65 at | 147.2^{a} | −57 | 3.02 |
| flash point | | | | | 40° C. | | | |
| grade) | | | | | | | | |
| ESCOREZ | 400 | 700 | 1300 | 1.83 | 800 at | ND | 52* | 1.4 |
| 5400 | | | | | 160° C.* | | | |
| CALSOL | 379 | 477 | 568 | 1.26 | ND | 221* | −42 | 0.9 |
| 5550 | | | | | | | | |
| KN-4010 | 431 | 468 | 506 | 1.13 | 163 cS at | 215* | −59 | 0.4 |
| | | | | | 40° C.* | | | |
| ER-400 | 373 | 634 | 1140 | 1.71 | 200 at | 200* | 55 | ND |
| | | | | | 180° C.^{b} | | | |
| REGALREZ | 312 | 403 | 547 | 1.29 | 10,000 at | 255* | −23* | 1.0 |
| 1018 | | | | | 40° C.* | | | |

^{a}based on the value reported in the manufacturer's product literature, which indicated the ASTM D93 “Pensky-Marten Closed Cup Test Method” was used to determine the value.
*based on the value reported in the manufacturer's product literature
ND = not determined
cS = centistoke
^{b}based on the value reported in the manufacturer's product literature, which indicated that GB/T3536-2008 Cleveland Open Cup Methods for flash point testing was used to determine the value.
JQ-4 low viscosity grade = JQ-4 liquid resin oil lot # 20211120 (Henghe Materials & Science Technology Co., Ltd., Ningbo, China)
JQ-4 high viscosity grade = JQ-4 liquid resin oil lot # 20211117 (Henghe Materials & Science Technology Co., Ltd.)
JQ-4 low flash point grade = JQ-4 liquid resin oil lot # 20211123 (Henghe Materials & Science Technology Co., Ltd.)
ESCOREZ 5400 = cycloaliphatic hydrocarbon resin (ExxonMobil Chemical Company, Houston, Texas)
CALSOL 5550 = naphthenic oil
KN-4010 = naphthenic oil (PetroChina Lubricant Company, Beijing, China)
ER-400 = hydrogenated hydrocarbon resin (EcoGreen Int'l Group Ltd., Xiamen, China)
REGALREZ 1018 = liquid hydrocarbon resin (Eastman Chemical Company, Kingsport, Tennessee)

### Examples E1-E7

The hot melt pressure sensitive adhesive compositions of Examples E1-E7 were prepared as follows. Polymer, plasticizer and antioxidants were loaded in mixer at a mixer temperature of from 130° C. to 170° C. and under vacuum or with a nitrogen blanket. The composition was then mixed for a period of at least 25 mins or until the polymer was molten and the mixture was homogeneous. Then tackifier(s) and any remaining components were sequentially added to the molten mixture, and the mixture was mixed under vacuum or a nitrogen blanket for at least 35 mins until the mixture was homogeneous.

The hot melt pressure sensitive adhesive compositions of Examples E1-E7 were then tested according to the Viscosity test method at the temperatures indicated, the Softening Point test method, and the Tg and Tx test method. The results are reported in Table 2.

TABLE 2

| | E1 | E2 | E3 | E4 | E5 | E6 | E7 |
|---|---|---|---|---|---|---|---|
| RIANOX | 0.4 | 0.4 | 0.4 | 0.4 | 0.4 | 0.4 | 0.4 |
| 1010FF | | | | | | | |
| UV-326 | 0.1 | 0.1 | 0.1 | 0.1 | 0.1 | 0.1 | 0.1 |
| KN-4010 | 0 | 0 | 0 | 0 | 0 | 4 | 5 |
| JQ-4 (Low | 24.7 | 26.5 | 0 | 0 | 0 | 0 | 0 |
| Viscosity | | | | | | | |
| grade) | | | | | | | |
| JQ-4 (High | 0 | 0 | 24.7 | 32 | 36 | 30 | 30 |
| Viscosity | | | | | | | |
| grade) | | | | | | | |
| JH-8161 | 5.6 | 5.6 | 5.6 | 5.6 | 5.6 | 5.6 | 5.6 |
| GLOBALP | 12.5 | 12.5 | 12.5 | 12.5 | 0 | 12.5 | 12.5 |
| RENE 3546 | | | | | | | |
| GLOBALP | 0 | 0 | 0 | 0 | 10 | 0 | 0 |
| RENE 3542 | | | | | | | |
| HANWHA | 45.7 | 0 | 45.7 | 0 | 0 | 0 | 0 |
| HC-100 | | | | | | | |
| ER-400 | 10 | 53.9 | 10 | 48.4 | 46.9 | 46.4 | 45.4 |
| RM-6328 | 0.5 | 0.5 | 0.5 | 0.5 | 0.5 | 0.5 | 0.5 |
| JINLUN | 0.5 | 0.5 | 0.5 | 0.5 | 0.5 | 0.5 | 0.5 |
| film | | | | | | | |
| Total | 100 | 100 | 100 | 100 | 100 | 100 | 100 |
| Viscosity | | | | | | | |
| (cP) | | | | | | | |
| at 180° C. | 1020 | 960 | 1253 | 990 | 880 | 910 | 900 |
| at 160° C. | 1825 | 1690 | 2440 | 1835 | 1560 | 1700 | 1533 |
| at 140° C. | 3742 | 3300 | 5308 | 3658 | 3350 | 3300 | 3110 |
| at 120° C. | 9300 | 8100 | 14,600 | 9300 | 7800 | 8000 | 7600 |
| Softening | 75 | 75 | 78.5 | 72 | 73 | 75 | 75 |
| point (° C) | | | | | | | |
| Tg (° C) | 13.2 | 11 | 22.3 | 15 | 14 | 11 | 9 |
| Crossover | 62 | 62 | 67 | 61 | 63.5 | 62 | 61.5 |
| Temperature | | | | | | | |
| Tx (° C) | | | | | | | |

RIANOX 1010FF = Pentaerythritol tetrakis(3-(3,5-di-tert-butyl-4-hydroxyphenyl)propionate)
UV-326 = UV-Blocker: 2-(2′-Hydroxy-3′-tert-butyl-5′-methylphenyl)-5-chlorobenzortriazole
KN-4010 = naphthenic oil (Lubricant Company of PetroChina Co. Ltd, China)
JH-8161 = Styrene-isoprene-styrene block copolymer (Ningbo Jinhai Chenguang Chemical Corporation, Zhejian, China)
GLOBALPRENE 3546 = Styrene-butadiene-styrene block copolymer (LCY Group, Taiwan)
GLOBALPRENE 3542 = Styrene-butadiene-styrene block copolymer (LCY Group)
HANWHA HC-100 = hydrogenated cycloaliphatic hydrocarbon resin (Hanwha Solutions, Seoul, Korea)
ER-400 = hydrogenated hydrocarbon resin (EcoGreen Chemical Industry Co., LTD., Zhangzhou, China)
RM-6328 = coextrusion coating
JINLUN film = ethylene vinyl acetate film

Test samples were then prepared from the compositions of Examples E2 and E7 according to the Dynamic Peel Adhesion PE/NW and NW/NW sample preparation methods, conditioned under the conditions and for the period of time specified in Table 3, allowed equilibrate to room temperature, and then tested according to the Dynamic Peel Adhesion Test Method. The results are reported in units of N/5.08 cm in Table 3. The samples conditioned for one week and four weeks were conditioned in an oven at 50′° C.

TABLE 3

| | | E7 | E2 | E7 | E2 |
|---|---|---|---|---|---|
| | Conditions | PE/NW | PE/NW | NW/NW | NW/NW |
| 1 Day | 20-25° C. and | 1.75 | 1.69 | 1.59 | 1.66 |
| | 45-55% | | | | |
| | Relative | | | | |
| | Humidity | | | | |
| 1 Week | 50° C. | 2.89 | 1.08 | 2.12 | 2.11 |
| 4 Weeks | 50° C. | 2.23 | 2.25 | 2.11 | NT |

### Examples E8-E9 and Control C1

The hot melt adhesive compositions of Examples E8-E9 and Control C1 were prepared as follows. Polymer, plasticizer, liquid resin oil, tackifying agent, wax and antioxidants were melted at 148° C. for 2.5 hours. The molten material was then mixed in a vertical blade mixer at 250 revolutions per minute and 150° C. for a period of at least one hour or until the polymer was molten and the mixture was homogeneous.

The hot melt pressure sensitive adhesive compositions of Examples E8-E9 and Control C1 were then tested according to the Tg and Tx test method. The results are reported in Table 4.

TABLE 4

| | C1 | E8 | E9 |
|---|---|---|---|
| IRGANOX 1010 | 0.19 | 0.2 | 0.2 |
| ENGAGE 8200 | 12.83 | 13 | 13 |
| Naphthenic Oil | 26.74 | 0 | 5 |
| JQ-4 high viscosity grade | 0 | 30 | 30 |
| liquid resin oil | | | |
| EPOLENE N-21 | 1.92 | 1.92 | 1.92 |
| ESCOREZ 5415 | 0.71 | 0.71 | 0.71 |
| SX105 WAX | 1.41 | 1.41 | 1.41 |
| ESCOREZ 5400 | 56.2 | 52.8 | 47.8 |
| Tx (° C.) | 69.7 | 72.8 | 67.4 |
| Tg (° C.) | 1.1 | 12.9 | 5.9 |

ENGAGE 8200 = polyethylene/polyoctene polyolefin (The Dow Chemical Company, Midland, Michigan)
EPOLENE N-21 = polyethylene wax (Westlake Chemical Corporation, Houston, Texas)
ESCOREZ 5415 = cycloaliphatic hydrocarbon resin (ExxonMobil Chemical Company, Houston, Texas)
SX105 = SARAWAX SX105 Fischer Tropsch wax (Evonik Corporation, Parsippany, New Jersey)
ESCOREZ 5400 = cycloaliphatic hydrocarbon resin (ExxonMobil Chemical Company)

### Examples E10

The hot melt adhesive composition of Example E10 was prepared as follows. Polymer, plasticizer, and antioxidants were loaded in a mixer at a mixer temperature of 150′° C. The composition was then mixed at 32 rotations per minute for 30 to 40 minutes or until the polymer was molten and the mixture was homogeneous. Then the tackifying agent and the remaining components were sequentially added to the molten mixture and the mixture was mixed under vacuum for 50 to 60 minutes until the composition was homogeneous.

The hot melt pressure sensitive adhesive composition of Example E10 was then tested according to the Viscosity, Tg, Tx, and Softening Point test methods. The results are reported in Table 5.

TABLE 5

| | E10 |
|---|---|
| RIANOX 1010FF | 0.4 |
| UV326 | 0.1 |
| KN4010 | 5 |
| JQ-4 (low flash point grade) | 30 |
| JH8161 | 5.6 |
| GLOBALPRENE 3546 | 12.5 |
| ER400 | 45.4 |
| RM-6328 | 0.5 |
| JINLUN film | 0.5 |
| Tx (° C.) | 53 |
| Tg (° C.) | −4.5 |
| Viscosity (cP) at | |
| 180° C. | 600 |
| 160° C. | 995 |
| 140° C. | 1900 |
| 120° C. | 4033 |
| Softening Point ° C. | 68.7 |

Other embodiments are within the claims.

1. A hot melt adhesive composition comprising: a polymer selected from the group consisting of thermoplastic polymer, elastomeric polymer, and combinations thereof; a tackifying agent; and a liquid resin oil derived from a waste stream of a tackifier resin polymerization process.

2. A hot melt adhesive composition comprising: a polymer selected from the group consisting of thermoplastic polymer, elastomeric polymer, and combinations thereof; a tackifying agent; and a liquid resin oil exhibiting a Tg from −60° C. to less than 0° C. (or from −40° C. to less than 0° C.), having an aromatic content of at least 1.5%, and having an Mz of no greater than 600 g/mol.

3. The hot melt adhesive composition of paragraph 1 or 2, wherein the liquid resin oil has an aromatic content of at least 1.5% and an Mz of no greater than 500 g/mol.

4. The hot melt adhesive composition of any one of paragraphs 1-3, wherein the liquid resin oil has an Mz no greater than 400 g/mol.

5. The hot melt adhesive composition of any one of paragraphs 1-4, wherein the liquid resin oil has an aromatic content of at least 2%.

6. The hot melt adhesive composition of any one of paragraphs 1-4, wherein the liquid resin oil has an aromatic content of at least 3%.

7. The hot melt adhesive composition of any one of paragraphs 1-4, wherein the liquid resin oil has an aromatic content of at least 4%.

8. The hot melt adhesive composition of any one of paragraphs 1 and 3-7, wherein the liquid resin oil has an aromatic content of at least 2% and a Mz of no greater than 800 g/mol.

9. The hot melt adhesive composition of any one of paragraphs 1 and 3-8, wherein the liquid resin oil exhibits a Tg of no greater than 0° C.

10. The hot melt adhesive composition of any one of paragraphs 1-9, wherein the liquid resin oil exhibits a Tg less than 0° C. (or from −60° C. to less than 0° C. or from −40° C. to less than 0° C.) and has an aromatic content of at least 1.5% and a Mz from 140 g/mol to 600 g/mol.

11. The hot melt adhesive composition of any one of paragraphs 1-9, wherein the liquid resin oil exhibits a Tg less than 0° C. (or from −60° C. to less than 0° C. or from −40° C. to less than 0° C.) and has an aromatic content of at least 1.5% and a Mz from 120 g/mol to 500 g/mol.

12. The hot melt adhesive composition of any one of paragraphs 1-11, wherein the thermoplastic polymer is selected from the group consisting of styrenic block copolymer, polyolefin polymer, amorphous polyalpha olefin, ethylene-polar comonomer copolymer, and combinations thereof.

13. The hot melt adhesive composition of any one of paragraphs 1-12, wherein the composition comprises less than 60% by weight tackifying agent.

14. The hot melt adhesive composition of any one of paragraphs 1-13, wherein the composition comprises less than 10% by weight plasticizer.

15. The hot melt adhesive composition of any one of paragraphs 1-14, wherein the composition further comprises liquid plasticizer, the percent by weight liquid resin oil in the hot melt adhesive composition being greater than the percent by weight percent liquid plasticizer in the hot melt adhesive composition.

16. The hot melt adhesive composition of any one of paragraphs 1-15, comprising from 10% by weight to 35% by weight polymer; from 30% by weight to 65% by weight of the tackifying agent; and from 5% by weight to 50% by weight of the liquid resin oil.

17. The hot melt adhesive composition of any one of paragraphs 1-15, comprising from 10% by weight to 35% by weight styrenic block copolymer; from 30% by weight to 65% by weight of the tackifying agent; and from 5% by weight to 50% by weight of the liquid resin oil.

18. The hot melt adhesive composition of any one of paragraphs 1-15, comprising from 10% by weight to 35% by weight polyolefin; from 30% by weight to 65% by weight of the tackifying agent; and from 5% by weight to 50% by weight of the liquid resin oil.

19. The hot melt adhesive composition of any one of paragraphs 1-15, comprising from 10% by weight to 35% by weight ethylene-polar comonomer copolymer; from 30% by weight to 65% by weight of the tackifying agent; and from 5% by weight to 50% by weight of the liquid resin oil.

20. The hot melt adhesive composition of any one of paragraphs 1-15, comprising from 10% by weight to 35% by weight amorphous polyalpha olefin; from 30% by weight to 65% by weight of the tackifying agent; and from 5% by weight to 50% by weight of the liquid resin oil.

21. The hot melt adhesive composition of any one of paragraphs 1-15 comprising from 10% by weight to 30% by weight polymer; from 35% by weight to 50% by weight of the tackifying agent; and from 15% by weight to 45% by weight of the liquid resin oil.

22. The hot melt adhesive composition of any one of paragraphs 1-15 comprising from 10% by weight to 25% by weight polymer; from 40% by weight to 50% by weight of the tackifying agent; and from 30% by weight to 45% by weight liquid resin oil.

23. The hot melt adhesive composition of any one of paragraphs 1-15, wherein the composition comprises at least 25% by weight of the liquid resin oil.

24. The hot melt adhesive composition of any one of paragraphs 1-23, wherein the composition is a hot melt pressure sensitive adhesive composition.

25. The hot melt adhesive composition of any one of paragraphs 1-24, wherein the hot melt adhesive composition exhibits a peel adhesion strength of at least 0.4 N/5.08 cm, when tested according to the Dynamic Peel Adhesion test method using a PE/NW test sample.

26. The hot melt adhesive composition of any one of paragraphs 1-25, wherein the hot melt adhesive composition exhibits a Tg from −15° C. to 35° C.

27. The hot melt adhesive composition of any one of paragraphs 1-26, wherein the hot melt adhesive composition exhibits a softening point greater than 60° C.

28. An article that includes a first substrate, the hot melt adhesive composition of any one of paragraphs 1-27, and a second substrate adhered to the first substrate through the hot melt adhesive composition.

What is claimed is:

1. A hot melt adhesive composition comprising:
a polymer selected from the group consisting of thermoplastic polymer, elastomeric polymer, and combinations thereof,
a tackifying agent; and
a liquid resin oil derived from a waste stream of a tackifier resin polymerization process.

2. (canceled)

3. The hot melt adhesive composition of claim 1, wherein the liquid resin oil has an Mz of no greater than 400 g/mol.

4. The hot melt adhesive composition of claim 1, wherein the liquid resin oil has an aromatic content of at least 2%.

5. The hot melt adhesive composition of claim 1, wherein the liquid resin oil has an aromatic content of at least 3%.

6. The hot melt adhesive composition of claim 1, wherein the liquid resin oil has an aromatic content of at least 4%.

7. The hot melt adhesive composition of claim 1, wherein the liquid resin oil exhibits a glass transition temperature (Tg) from −60° C. to less than 0° C., has an aromatic content of at least 1.5%, and has an Mz from 140 g/mol to 600 g/mol.

8. The hot melt adhesive composition of claim 1, wherein the liquid resin oil exhibits a Tg from −60° C. to less than 0° C., has an aromatic content of at least 1.5%, and has an Mz from 120 g/mol to 500 g/mol.

9. The hot melt adhesive composition of claim 1, wherein the thermoplastic polymer is selected from the group consisting of styrenic block copolymer, polyolefin polymer, amorphous polyalpha olefin, ethylene-polar comonomer copolymer, and combinations thereof.

10. The hot melt adhesive composition of claim 1, wherein the composition further comprises liquid plasticizer, the percent by weight liquid resin oil in the hot melt adhesive composition being greater than the percent by weight percent liquid plasticizer in the hot melt adhesive composition.

11. The hot melt adhesive composition of claim 1, comprising
from 10% by weight to 35% by weight of the polymer;
from 30% by weight to 65% by weight of the tackifying agent; and
from 5% by weight to 50% by weight of the liquid resin oil.

12. The hot melt adhesive composition of claim 1, comprising
from 10% by weight to 30% by weight of the polymer;
from 35% by weight to 50% by weight of the tackifying agent; and
from 15% by weight to 45% by weight of the liquid resin oil.

13. The hot melt adhesive composition of claim 1, comprising
from 10% by weight to 25% by weight of the polymer;
from 40% by weight to 50% by weight of the tackifying agent; and
from 30% by weight to 45% by weight liquid resin oil.

14. The hot melt adhesive composition of claim 1, wherein the hot melt adhesive composition exhibits a softening point greater than 60° C.

15. An article comprising:
a first substrate,
the hot melt adhesive composition of claim 1, and
a second substrate adhered to the first substrate through the hot melt adhesive composition.

16. The hot melt adhesive composition of claim 1, comprising from 10% by weight to no greater than 30% by weight of the polymer.

17. The hot melt adhesive composition of claim 1, wherein the liquid resin oil exhibits a Tg from −40° C. to less than 0° C.

18. A hot melt adhesive composition comprising:
a polymer selected from the group consisting of thermoplastic polymer, elastomeric polymer, and combinations thereof,
a tackifying agent; and
a liquid resin oil exhibiting a Tg from −60° C. to less than 0° C., having an aromatic content of at least 1.5%, and having an Mz of no greater than 600 g/mol.

19. The hot melt adhesive composition of claim 18, comprising
from 10% by weight to 30% by weight of the polymer;
from 35% by weight to 50% by weight of the tackifying agent; and
from 15% by weight to 45% by weight of the liquid resin oil.

20. The hot melt adhesive composition of claim 18, comprising
from 10% by weight to 25% by weight of the polymer;
from 40% by weight to 50% by weight of the tackifying agent; and
from 30% by weight to 45% by weight liquid resin oil.
